(19) United States
(12) Patent Application Publication
(10) Pub. No.: US 2025/0230677 A1
(43) Pub. Date: Jul. 17, 2025

(54) CLIP APPLICATOR

(71) Applicant: Dayton Superior Corporation, Miamisburg, OH (US)

(72) Inventor: Jonathan Louis Hankenhof, Milford, OH (US)

(21) Appl. No.: 19/023,782

(22) Filed: Jan. 16, 2025

Related U.S. Application Data
(60) Provisional application No. 63/621,265, filed on Jan. 16, 2024.

(51) Int. Cl. E04G 21/12; B25B 27/02

(52) U.S. Cl. CPC E04G 21/122; B25B 27/026

(57) ABSTRACT

An apparatus for coupling a clip to a bar, the apparatus including a barrel defining a barrel cavity therein, wherein the barrel cavity is sized and positioned to receive a clip therein, and a piston configured for reciprocable movement in the barrel cavity to thereby drive a clip positioned in the cavity out of the cavity. The apparatus further includes a sleeve configured for reciprocable movement in the barrel cavity. The sleeve has a sleeve cavity having smaller cross sectional area than a cross sectional area of the barrel cavity to thereby receive a relatively smaller clip therein.

This application claims priority to U.S. Provisional Patent Application Ser. No. 63/621,265, filed on Jan. 16, 2024, the entire contents of which are hereby incorporated by reference.

The present disclosure is directed to a clip applicator, and more particularly, to a clip applicator that can accommodate differently-sized clips.

### BACKGROUND

Clip applicator are commonly used to apply clips to reinforcing bars. For example, such clip applicators can be used to attach reinforcing bars together prior to pouring concrete over the attached reinforcing bars, to thereby create reinforced concrete structures. Reinforcing bars can come in differing sizes and/or shapes. However many existing clip applicators are only able to apply a single size of clip. Thus in order to apply differently-sized clips, differing clip applicators, which dispense differently-sized clips, may be maintained on a job site. However the use of different tools leads to increased complexity and loss of efficiency, since the operator must store and locate different types of clip applicators. The use of differing clip applicators for differently-sized clips also leads to increased expense in purchasing and maintaining different clip applicators.

### SUMMARY

In one embodiment the present disclosure is directed to a clip applicator that can be quickly, easily and intuitively adjusted to apply differently-sized clips. More particularly, in one embodiment the invention is an apparatus for coupling a clip to a bar including a barrel defining a barrel cavity therein, where the barrel cavity is sized and positioned to receive a clip therein. The apparatus further includes a piston configured for reciprocable movement in the barrel cavity to thereby drive a clip, positioned in the cavity, out of the cavity. The apparatus has a sleeve configured for reciprocable movement in the barrel cavity, where the sleeve has a sleeve cavity having smaller cross sectional area than a cross sectional area of the barrel cavity to thereby accommodate relatively smaller clips therein.

### BRIEF DESCRIPTION OF DRAWINGS

FIG. 1 is a front perspective view of a clip applicator, with an outer protective guard of the barrel removed, and with an outer casing of the feed mechanism removed, for illustrative purposes;

FIG. 2 is a rear perspective view of the clip applicator of FIG. 1;

FIG. 3 is an upper perspective view of one embodiment of a clip that can be used in the clip applicator of FIGS. 1 and 2;

FIG. 3A is a lower perspective view of the clip of FIG. 3;

FIG. 4 shows the clip of FIG. 3 coupled to two reinforcing members in a first arrangement;

FIG. 5 shows the clip of FIG. 3 coupled to two reinforcing members in a second arrangement;

FIG. 6 shows a string of clips, of the clip of FIG. 3; and

FIG. 7 is a lower perspective view of the clip applicator of FIG. 1, showing the location where the clip string is fed into the barrel;

FIG. 8 is a side cross section of the part of the barrel and feed mechanism of the clip applicator of FIG. 1, with a relatively small clip therein, with the sleeve in an engaged position and with the piston in a retracted position;

FIG. 8A shows the system of FIG. 8, with the sleeve in a retracted position;

FIG. 9 shows the system of FIG. 8, with the piston engaging a clip;

FIG. 10 shows the system of FIG. 9, with the piston pushing the clip out of the barrel;

FIG. 10A is a side cross section of the part of the barrel and feed mechanism of the clip applicator of FIG. 1, with a relatively large clip therein, with the sleeve in a retracted position and with the piston pushing the clip out of the barrel;

FIG. 11 is a detail view of the clip applicator of FIG. 1, with the outer casing of the feed mechanism included, applying a clip to a set of reinforcing members;

FIG. 12 is an end view of the barrel of the clip applicator of FIG. 1, with a relatively smaller clip received in the barrel, where the clip, barrel and sleeve are shaded for ease of illustration;

FIG. 13 is an exploded view of the sleeve and the barrel of the clip applicator of FIG. 1;

FIG. 14 is another perspective view of the barrel of FIG. 13;

FIG. 15 is another perspective view of the sleeve of FIG. 13;

FIG. 16 is a side view of the barrel of the clip applicator of FIG. 1, showing the sleeve in a retracted position;

FIG. 17 is a side cross section of the barrel of FIG. 16;

FIG. 18 is a side view of the barrel of the clip applicator of FIG. 1, showing the sleeve in an engaged position;

FIG. 19 is a side cross section of the barrel of FIG. 18;

FIG. 20 is a side view of the barrel of the clip applicator of FIG. 1, showing the sleeve in an engaged position, and with a relatively smaller clip received in the barrel; and

FIG. 21 is an end view of the barrel of the clip applicator of FIG. 1, with a relatively larger clip received in the barrel, with the clip and the barrel shaded for ease of illustration.

### DETAILED DESCRIPTION

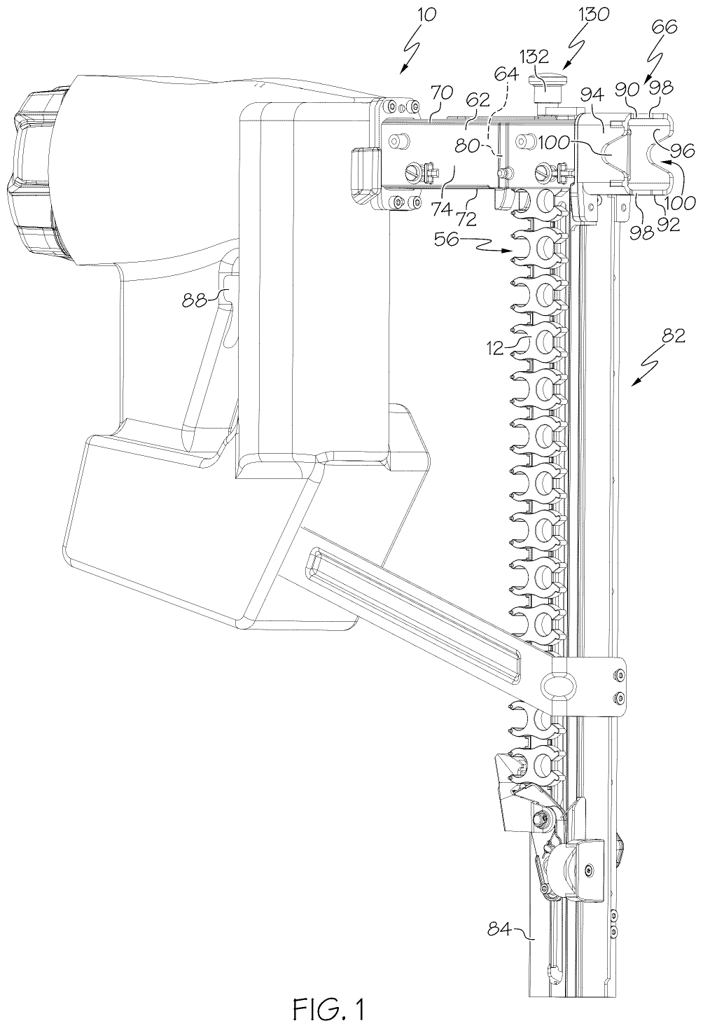

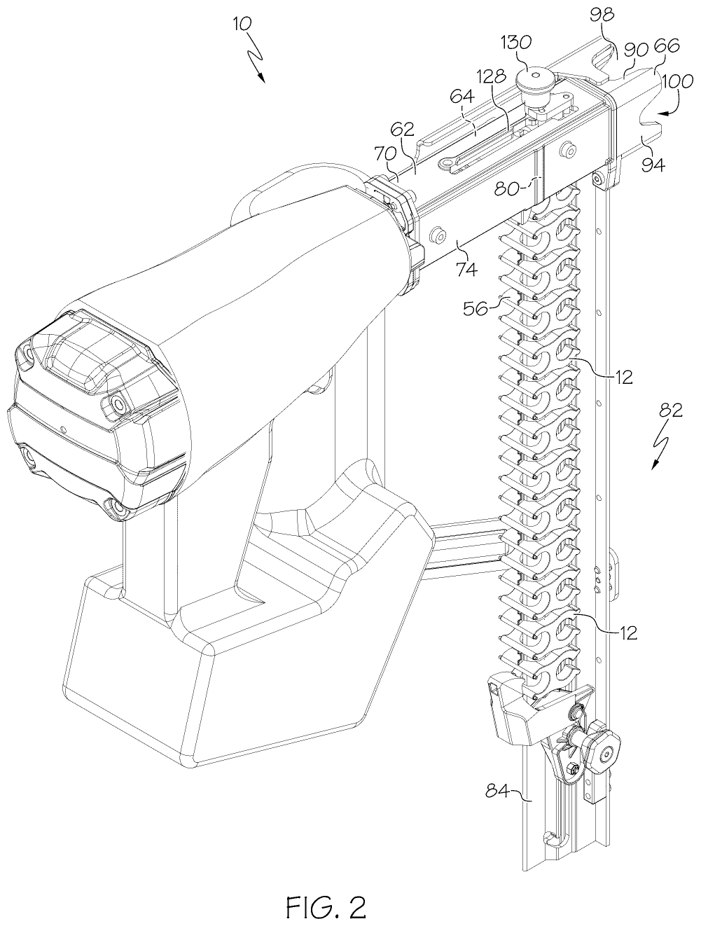

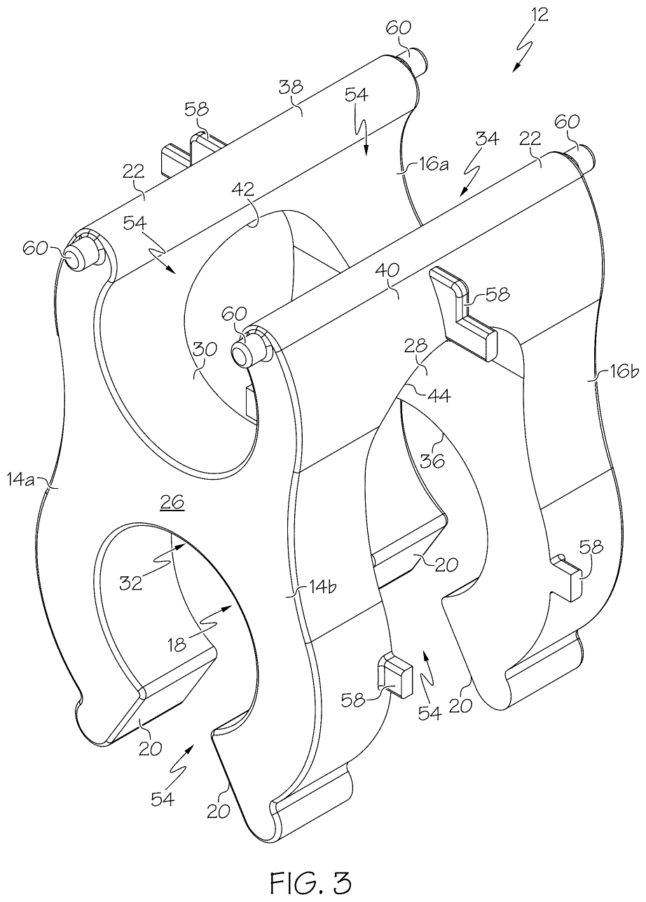

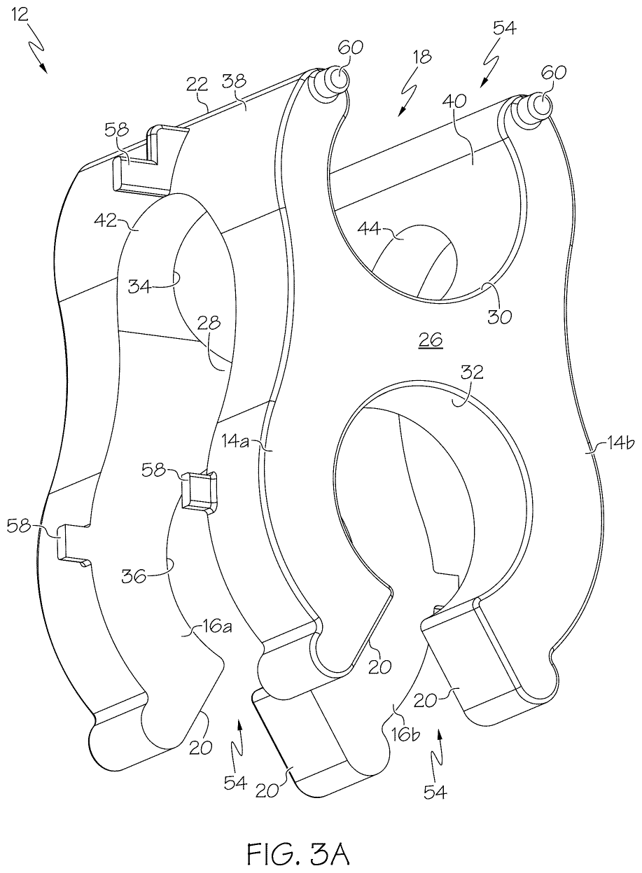

With reference to FIGS. 1 and 2, in one embodiment the clip applicator, generally designated 10, can be used in conjunction with, and dispense and/or apply, a plurality of clips 12, with reference for example to FIGS. 3 and 3A. Each clip 12 can be bilaterally symmetrical and include first pair of opposed clip arms 14a, 14b and a second pair of opposed clip arms 16a, 16b. The clip 12 can have a generally rectangular prism shape, with an arm 14a, 14b, 16a, 16b located at each corner thereof. In the illustrated embodiment each clip arm 14a, 14b, 16a, 16b extends a full height of the clip 12, and the arms 14a, 14b, 16a, 16b define a central clip cavity 18 therebetween. Each of the clip arms 14a, 14b, 16a, 16b can have a tapered/angled surface 20 at a one end (a lower end) thereof, and a rounded surface 22 at the opposite end (upper end) thereof. Each tapered surface tapers/angles toward the central clip cavity 18, moving in a direction toward the central clip cavity 18.

The first pair of clip arms 14a, 14b are coupled by a first bridge portion 26 extending generally transverse to a length of the clip arms 14a, 14b. The second pair of clip arms 16a, 16b are correspondingly coupled by a second bridge portion 28 extending generally transverse to a length of the clip arms 16a, 16b. The first 26 and second 28 bridge portions are oriented parallel to each other and positioned on opposite sides of the clip 12/clip cavity 18. The first bridge portion 26 and first arms 14a, 14b define a pair of aligned bar seats 30, 32 on opposed (upper and lower, respectively) sides of the first bridge portion 26, and the second bridge portion 28 and second arms 16a, 16b define a pair of aligned bar seats 34, 36 on opposed sides of the second bridge portion 28.

Each clip 12 further includes a first transverse portion 38, that extends from one end (an upper end) of the arm 14a to an end (the upper end) of the arm 16a. Each clip 12 can further have a second transverse portion 40 that extends from one end (an upper end) of the arm 14b to an end (an upper end) of the arm 16b. The first 38 and second 40 transverse portions can be oriented parallel to each other and be positioned on opposite sides of the clip 12/clip cavity 18 and can be curved or angled on their outer (upper) surfaces.

The first transverse portion 38 and the associated arms 14a, 16a define a seat 42 on the lower side of the first transverse portion 38, and the second transverse portion 40 and the associated arms 14b, 16b define a seat 44 on the lower side of the second transverse portion 40. The seats 42, 44 are generally aligned and positioned on opposite sides of the clip 12/clip cavity 18.

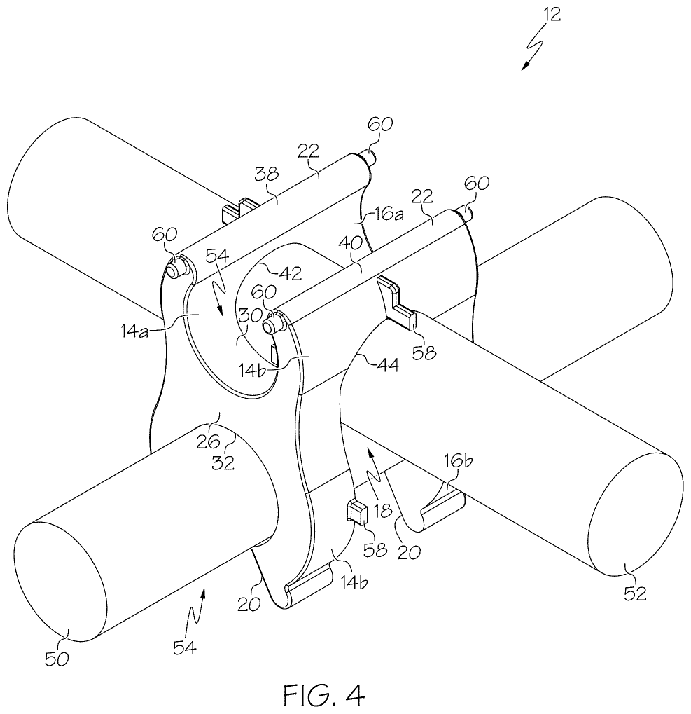

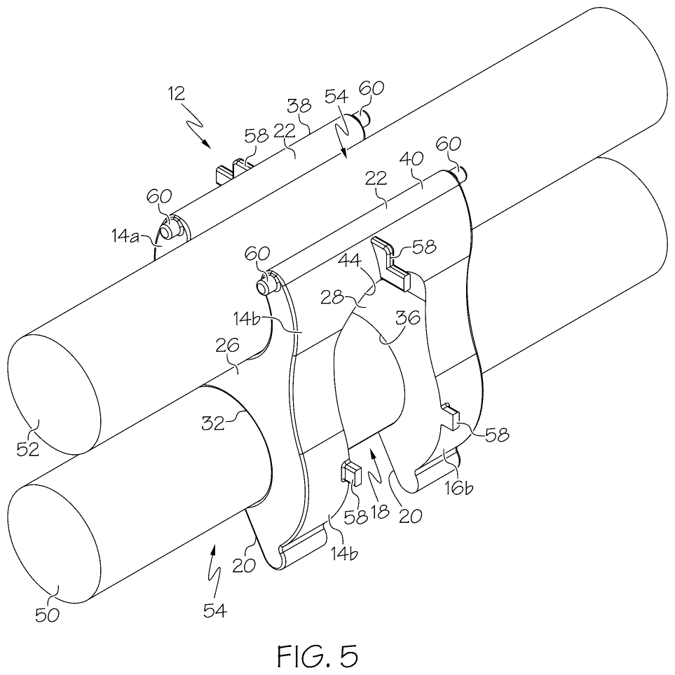

Each seat 30, 32, 34, 36, 42, 44 can be arcuate or generally arcuate (shaped as a portion of a circle) in end view in one case, to conform to a cylindrical or generally cylindrical reinforcing member or structural member 50, 52 to be received therein as described in greater detail below and shown in FIGS. 4 and 5. The seats 30, 32, 34, 36 can each have or define a gap 54 therebetween at its distal end. Each clip 12 can be made of a relative stiff, but elastically deformable material, such as plastic, polymers, fiberglass, composite materials, or combinations thereof.

Each clip 12 can be configured to be coupled to/mounted on one or more reinforcing members or reinforcing bars 50, 52, such a longitudinally extending piece of metal that is generally cylindrical in one case, such as rebar. In one case each clip 12 can be configured to be mounted to two reinforcing members 50, 52 in two different orientation. For example, as shown in FIG. 4, a clip 12 can be mounted to two reinforcing members 50, 52 in a first orientation wherein (upper) reinforcing member 52 is received in seats 42, 44 and the other (lower) reinforcing member 50 is received in seats 32, 36, and the reinforcing members 52, 50 are oriented perpendicular to each other. In another embodiment, as shown in FIG. 5, (upper) reinforcing member 52 is received in seats 30, 34 and the other (lower) reinforcing member 50 is received in seats 32, 36, and the reinforcing members 50, 52 are oriented parallel to each other.

Each reinforcing member 50, 52 can have a diameter that is greater than the gap 54 of the seats 30, 32, 34, 36. Thus, to insert a reinforcing member into the clip 12, a reinforcing member 50, 52 can be positioned at the gap 54 and externally of the associated seat 30, 32, 34, 36. When the clip 12/reinforcing member 50 or 52 are urged toward each other, the portions of the associated arms 14a, 14b, 16a, 16b are deformed outwardly, away from each other such that the reinforcing member 50, 52 can pass through the gap 54 and the arms 14a, 14b, 16a, 16b, and be received in the associated seat 30, 32, 34, 36. The angled 20/curved 22 tips of the arms 14a, 14b, 16a, 16b helps to guide the reinforcing member 50, 52 into the seat 30, 32, 34, 36/clip 12. The arms 14a, 14b, 16a, 16b then return to their original, undeformed (or substantially undeformed) position such that the reinforcing member 50, 52 is trapped and retained in the seat 30, 32, 34, 36/clip 12, as shown in FIGS. 4 and 5. In this manner, each clip 12 can be coupled to two reinforcing members 50, 52 that are oriented perpendicular or parallel to each other, and spaced apart a predetermined distance. Further details relating to such clips 12 can be found in U.S. Pat. Nos. 8,117,796, and 9,394,692 the entire contents of which are hereby incorporated by reference.

When a clip 12 is coupled to a pair of reinforcing members 50, 52, as shown in FIGS. 4 and 5, each reinforcing member 50, 52 is securely coupled to and received in a seat of the associated clip 12. Each seat 30, 32, 34, 34, 36, 42, 44 can have a diameter that corresponds, or generally corresponds, to a diameter of the reinforcing member 50, 52 (e.g. is within +/−3% in one case, or is within +/−5% in another case). The reinforcing members 50, 52 (and other reinforcing members 50, 52, not shown) can be arranged in a row, grid or the like, and coupled to each other by the clips 12, which retain the reinforcing members 50, 52 in place and maintain a desired spacing between the reinforcing members 50, 52. Once the reinforcing members 50, 52 are arranged as desired (such as in a grid), liquid or slurry concrete can then be poured on and over the reinforcing members 50, 52 and clips 12, immersing the reinforcing members 50, 52 and clips 12. The concrete is then allowed to cure about the reinforcing members 50, 52 to form a reinforced concrete component.

In the illustrated embodiment, the clips 12 are configured such that clips 12 have three sets of seats: set 30 and 34; set 32 and 36; and set 42 and 44. Two sets of seats (sets 30, 34 and 32, 36) have or define central axes that are parallel, and one set of seats (set 42, 44) has or defines a central axis that is perpendicular to the other seats (30, 32, 34, 36). However the clips 12 can have any of a wide variety of shapes and configurations beyond those shown herein, including in one case having only two sets of seats which have or define central axes that are either parallel or perpendicular to each other, and the clip applicator 10 can be used with any such clips.

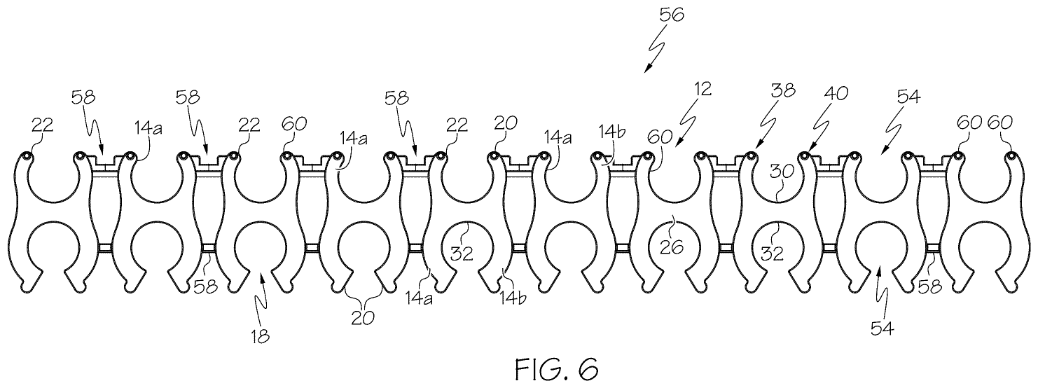

As shown in FIG. 6, a plurality of clips 12 can be coupled together to form a row or string 56 of clips 12 for use in/with the clip applicator 10. In the illustrated embodiment (see FIGS. 3, 3A and 6), each clip 12 in the clip string 56 is coupled to any adjacent clip by one or more frangible tabs 58. Each tab 58 can extend in a lateral direction, parallel to the length of the clip string 56 and perpendicular or parallel to the axis defined by at least one seat 30, 32, 34, 36. In the illustrated embodiment, two rows of frangible tabs 58 are located along the top edge of the clip string 56, and another row of frangible tabs 58 are located along the bottom edge of the clip string 56. Each clip 12 can also include two pair of relatively small alignment protrusions 60 (sec FIGS. 3 and 3A) on opposite sides of the first 38 and second 40 transverse portions extending outwardly from a body of the clip 12, for purposes which will be explained below. In the illustrated embodiment each alignment protrusion 60 is oriented perpendicular to the length of the string 56, and perpendicular to the frangible tabs 58, and positioned on opposite sides of the associated clip 12.

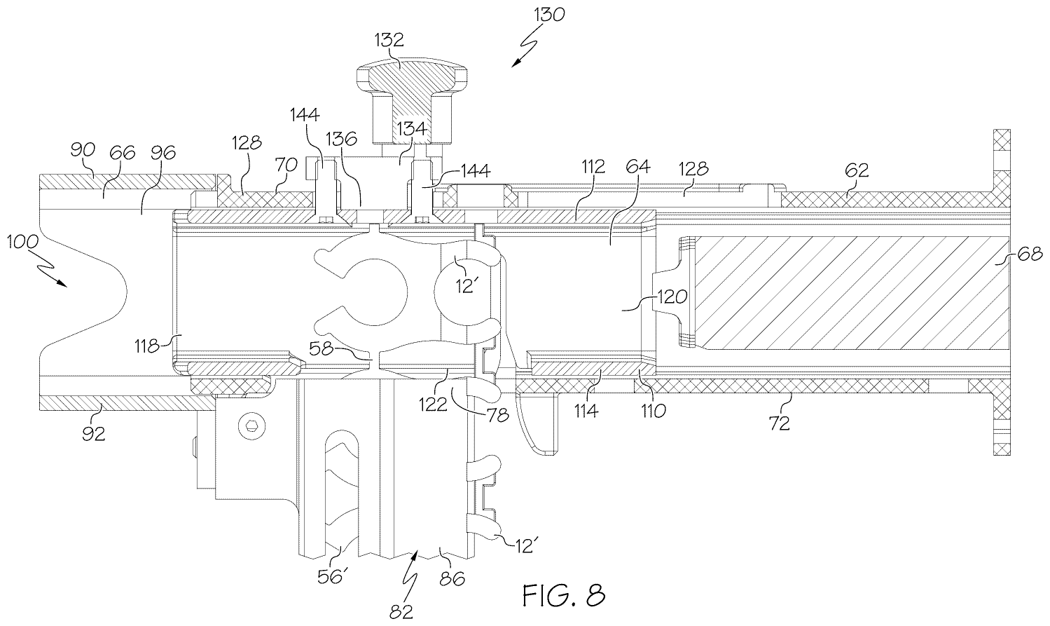

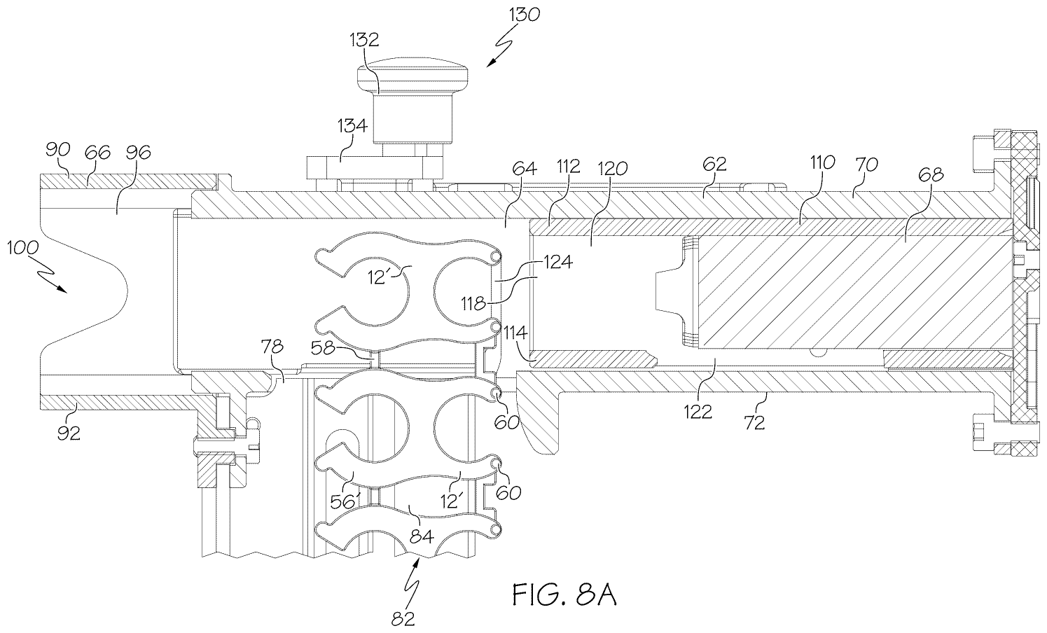

With reference to FIGS. 1 and 2 the clip applicator 10 can include, generally speaking, a barrel 62 defining a cavity or channel 64 therein for receiving a clip 12, an alignment head 66 located at and/or defining a distal end of the barrel 62, and a piston 68 (FIGS. 8-10) configured for reciprocable movement in the cavity 64. The barrel 62 is tubular and hollow in one case, having a generally square/rectangular cross section in one case (e.g. being square/rectangular in cross section, with rounded corners for case of manufacturing and to increase the strength of the barrel 62). The barrel 62 can thus have a top 70 and bottom 72 wall, and two opposed side walls 74, 76 (where “top” and “bottom” orientations apply when the clip applicator 10 is in the configuration shown in FIG. 1).

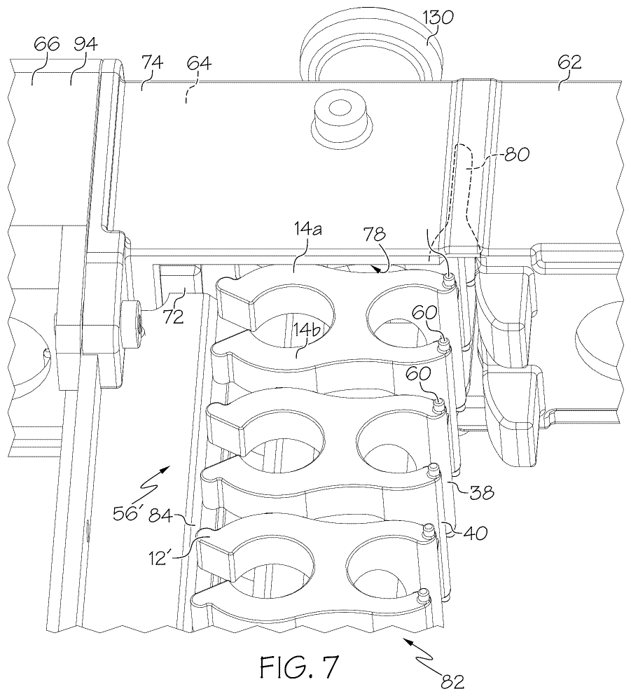

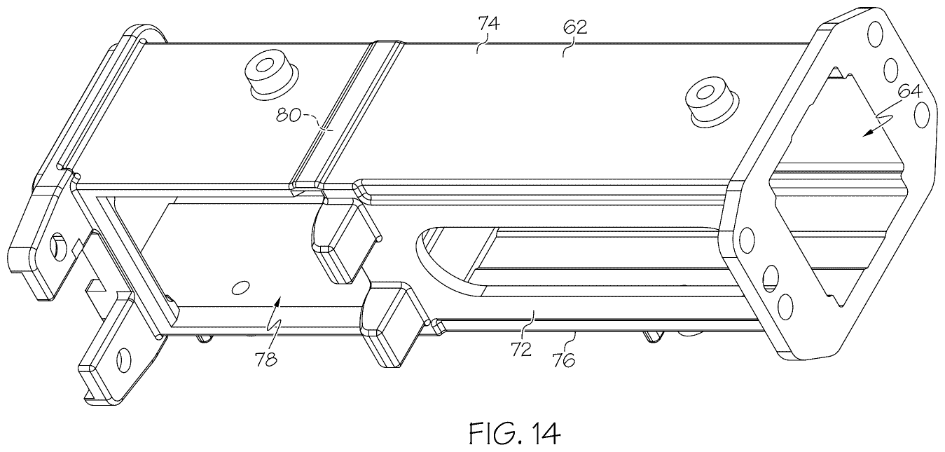

The bottom wall 72 of the barrel 62 has or defines a barrel slot 78 formed therein (where the barrel slot 78 is positioned between the side walls 74, 76 (see FIG. 14)). In addition, the inner surface of one or both side walls 74, 76 of the barrel 62 can have a barrel channel 80 formed therein (see FIGS. 7 and 14), for purposes which will be described in greater detail below. In the illustrated embodiment each barrel channel 80 is a recessed groove formed in inner surface of the side wall(s) 74, 76, but could also be a through-opening formed in the side walls 74, 76.

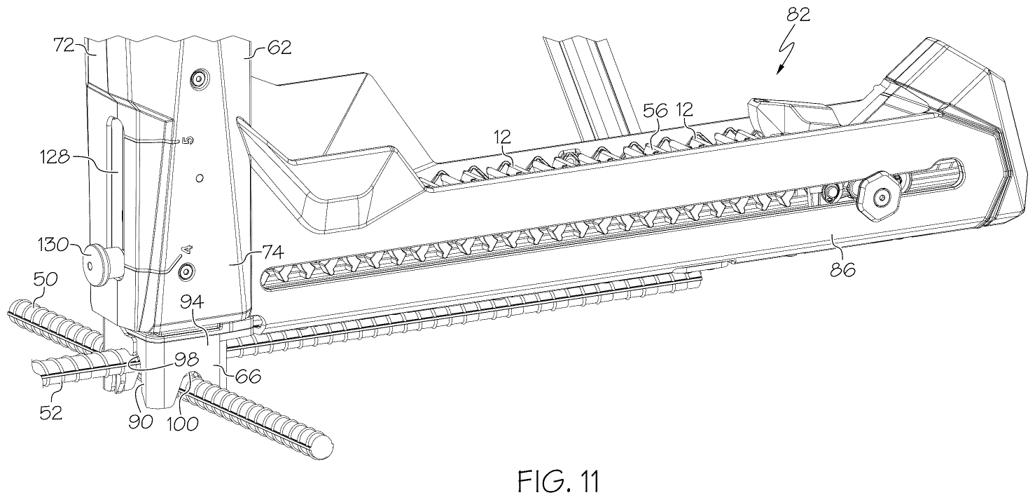

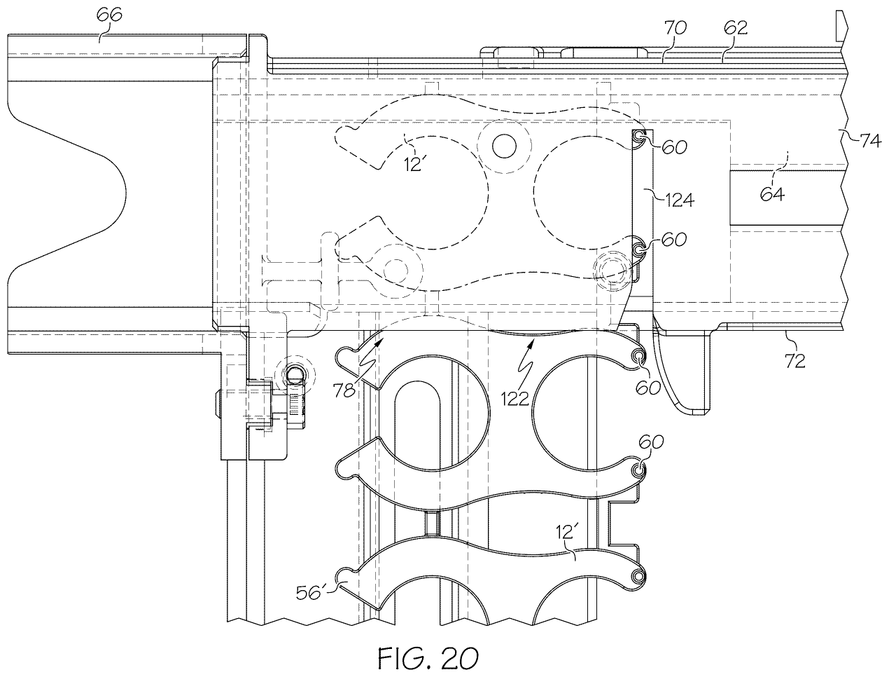

Returning to FIGS. 1 and 2, the clip applicator 10 can include a feed mechanism 82 that includes an outer casing 86 (FIG. 11) with an inner alignment fin 84 extending therein. The feed mechanism/outer casing 86 receives a clip string 56 therein, with the alignment fin 84 received through the central cavity 18 of the clips 12, to properly align and position the clip string 56 within the feed mechanism 82. As shown in FIGS. 1 and 2, the feed mechanism 82 and clip string 56 are each oriented vertically and oriented perpendicular to a length of the barrel 62. The feed mechanism 82 and clip string 56 are aligned with the barrel slot 78 and configured such that the clip string 56 (or at least a distal/inner-most clip 12 of the clip string 56) is received through the barrel slot 78 and positioned in the cavity 64 of the barrel 62, as shown in FIGS. 7 and 20. The barrel slot 78 is thus positioned and configured to receive a clip 12 therethrough and into the barrel 62, in a direction perpendicular to the length of the barrel 62. The barrel slot 78 thus can be considered to define a feed location 78, which is a location, along a length of the barrel 62, at which clips 12 are inserted into the barrel 62.

Each barrel channel 80 is sized and positioned to closely and slidably receive an alignment protrusion 60 of the barrel-mounted clip 12 therein (see FIG. 7), to ensure the clip 12 is properly positioned in the barrel 62. The barrel channels 80 thus helps to ensure the barrel-mounted clip 12 is properly aligned, and also helps to retain the last clip 12, of a string of clips 56, in place in the barrel 62 when the string 56 is otherwise consumed (e.g. via an interference fit in one case), to prevent the last clip 12 from falling out of place/exiting through the barrel slot 78.

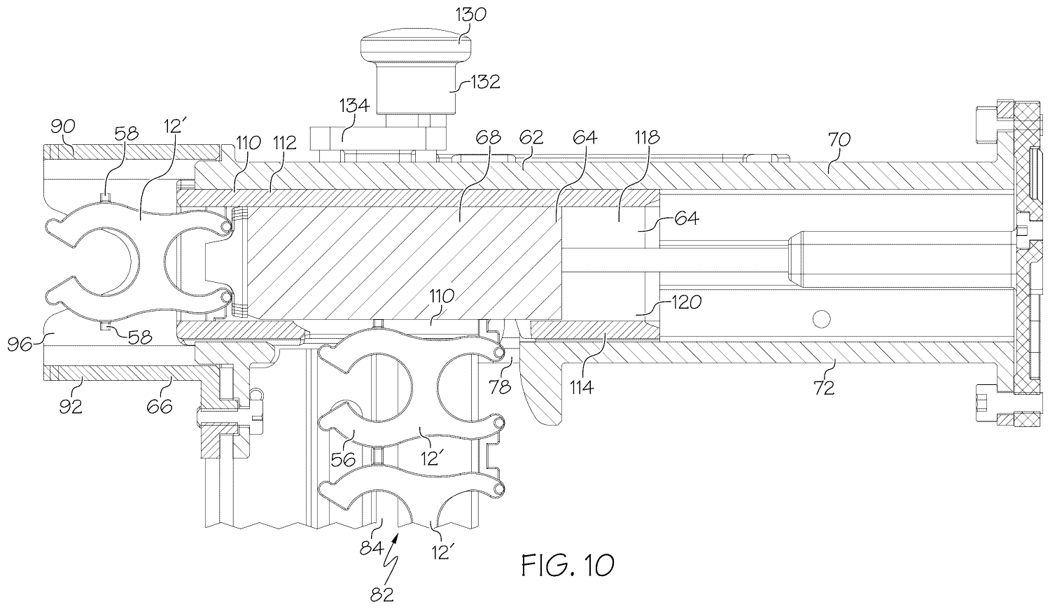

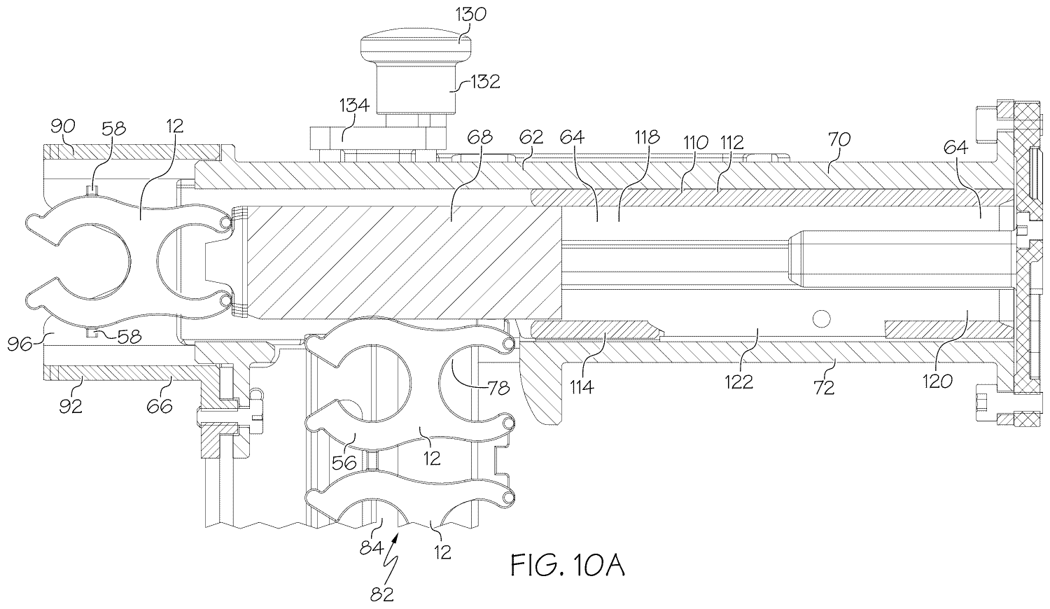

The piston 68 is configured for reciprocable movement in the cavity 64 to thereby drive a clip 12 positioned in the cavity 64, out of the cavity 64 and into engagement with a reinforcing member 50, 52. In particular, the piston 68 is movable from a retracted position (where the piston 68 is positioned upstream of the barrel slot 78) (FIGS. 8 and 8A) to an extended position in which a clip 12, positioned in the barrel 62, is ejected from the barrel 62 (FIGS. 10 and 10A). In one case the clip applicator 10 includes an actuator, such as switch/trigger 88 (FIG. 1), that is manually operable to cause the piston 68 (assuming all safety interlocks (not shown) are properly actuated) to move to its extended position, thereby moving downstream and pushing a clip 12 out of the barrel 62. In another case the clip applicator 10 can include one or more sensors, and the piston 68 is configured to automatically move from the retracted position to the extended position when the clip applicator 10 senses that the clip applicator 10 is properly positioned about the reinforcing members 50, 52, (assuming all safety interlocks are properly actuated).

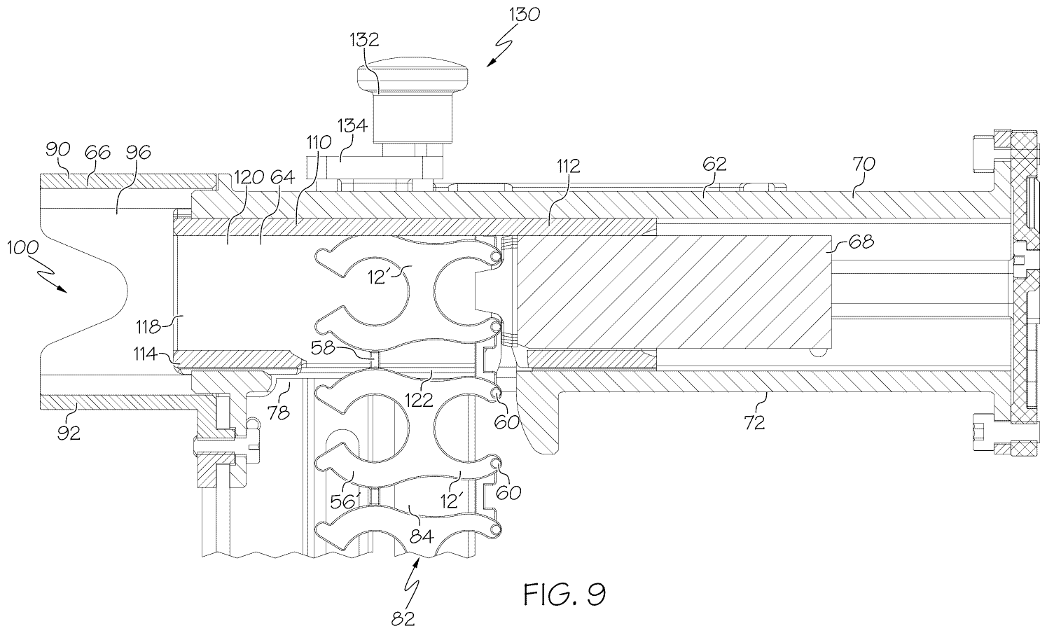

When the piston 68 moves from the retracted position (FIGS. 8, 8A) to the extended position, the piston 68 engages the clip 12 positioned in the barrel 62 (FIG. 9). Then as the piston 68 continues to move downstream (in one case further toward the extended position) and down the length of the barrel 62, the piston 68 breaks the frangible tabs 58 holding the clip 12 to the remainder of the clip string 56. The clip 12 is then moved along the length of the barrel 62 as shown in FIGS. 10 and 10A, and ultimately pressed onto the bars 50, 52, shown in FIG. 11 as being pressed onto two perpendicular bars 50, 52 in the illustrated embodiment.

The piston 68 can be actuated/powered by hydraulic forces/pressure, electrical power (electric motor) (either from a battery or a hard-wired source) or other motive forces. Once the barrel-mounted clip 12 is ejected, the piston 68 is automatically returned to its retracted position. The clip string 56 is then indexed inwardly (upwardly) such that the inner-most (upper-most) clip 12 is then positioned in the barrel 62 and positioned for ejection/coupling.

With reference to FIG. 1, the alignment head 66 has a generally rectangular cross section in the illustrated embodiment, having a top wall 90 and bottom wall 92, and two opposed side walls 94, 96 that generally correspond to, and/or are aligned with, the top wall 70, bottom wall 72 and opposed side walls 74, 76 of the barrel 62, respectively, in one case. The top wall 90 and bottom wall 92 of the alignment head 66 can have a first pair of aligned notches 98 formed therein, and the opposed sides walls 94, 96 have a second pair of aligned notches 100 formed therein. One pair of notches 98 (the first pair of notches 98 formed in the top 90 and bottom 92 wall, in the illustrated embodiment) can have a greater depth (e.g. in the axial direction of the barrel 62 and piston 68) than the other (second) pair of notches 100.

The first pair of notches 98 can be deeper than the second pair of notches 100 so that when the alignment head 66 is placed over a pair of transverse reinforcing members 50, 52 as shown in FIG. 11, the seats of the deeper notches 98 can engage the upper reinforcing member 52. The seats of the shallower notches 100 can simultaneously engage the lower reinforcing member 50 so that the alignment head 66 is properly position upon the crossed reinforcing members 50, 52. If the clip 12 is to be applied to two parallel reinforcing members 50, 52 as shown in FIG. 5, the alignment head 66 can receive the lower one of the reinforcing members 50 in the shallower notches 100, and the clip 12 can be can be coupled to the lower reinforcing member 50 by the clip applicator 10, and received in seats 32, 36. The upper reinforcing member 52 can then be manually positioned in the seats 30, 34 and positioned on top of the lower reinforming member 50.

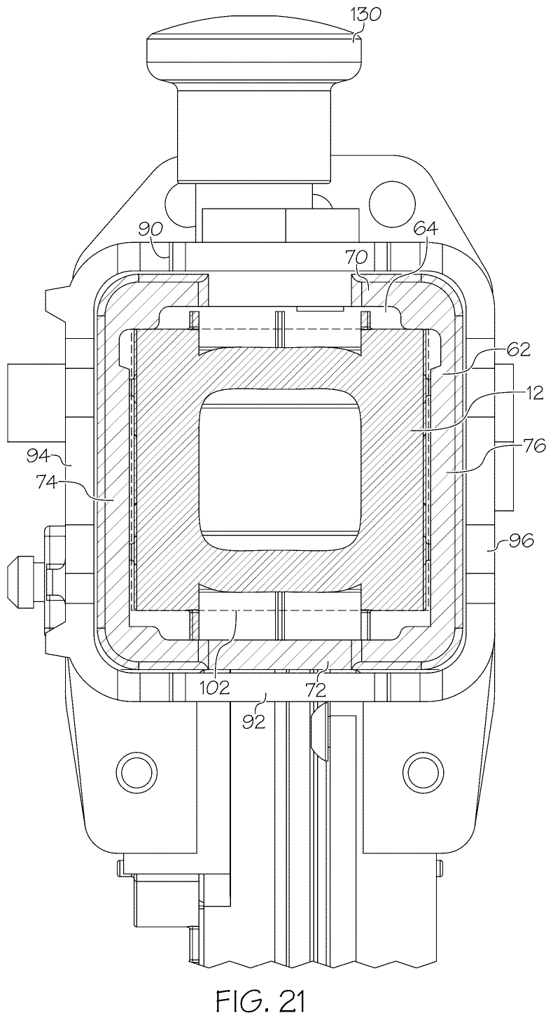

As shown in FIGS. 10A and 21, the barrel 62 can be configured to closely receive a clip 12 therein. In particular, in one case the barrel 62 can have an inner hollow cross-sectional surface area (defined in one case as a rectangle defined by the inner-most portions of the walls 70, 72, 74, 76 of the barrel 62) that corresponds (within about 1% in one case, or within about 3% in another case, or within about 5% in yet another case) to a “surface area” of a clip 12, wherein the surface area of the clip 12 is defined by the smallest rectangle drawn about the clip 12 when the clip 12 is received in the barrel 62 (as viewed looking down a length of the barrel 62), as shown by the dashed line rectangle 102 of FIG. 21 (where the rectangle 102 is slightly spaced away from the sides of the clip 12 for illustrative purposes). The barrel 62 can be configured to closely receive the clip 12 so that the clip 12 travels smoothly down the barrel 62 when the clip 12 is ejected, and so that the clip 12 does not bind or stick in the barrel 62.

In some cases it may be desired to configure the clip applicator 10 so that it is used with clips of at least two different sizes: a relatively large clip 12 (having a relatively large “surface area” (as defined above) and a relatively small clip 12′ having a relatively small “surface area.”) The relatively large clips 12 and relatively small clips 12′ can have the same shape, features, and use in operation as described above, but simply vary, in one case, by their relative dimensions and be configured for use with differently-size reinforcing members 50, 52.

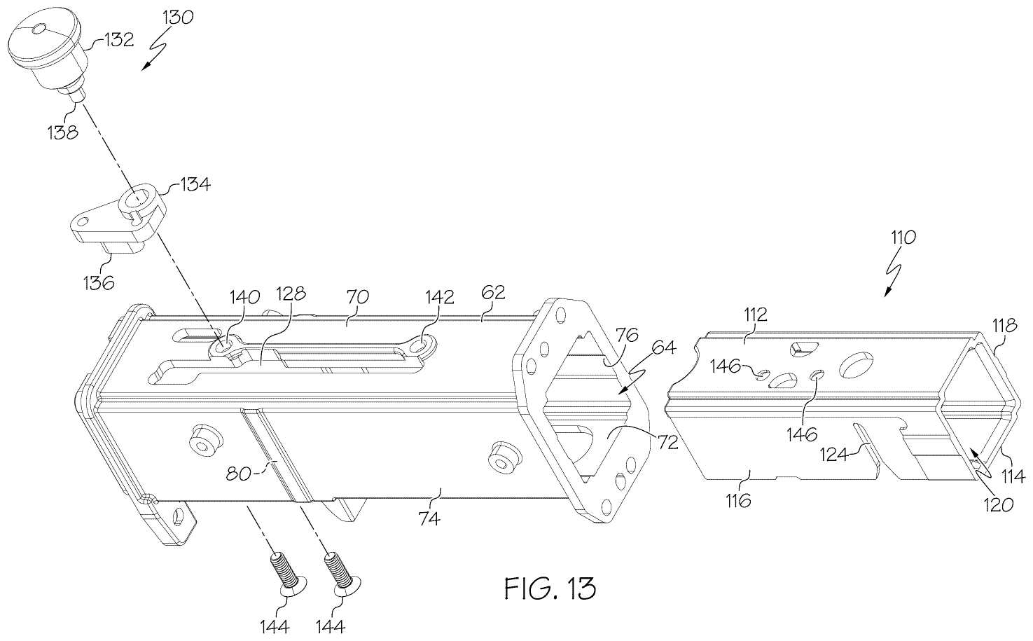

With reference to FIG. 13, the clip applicator 10 can in one case include a sleeve 110 positioned in the barrel 62/cavity 64, where the sleeve 110 can be used when the clip applicator 10 is desired to dispense relatively smaller clips 12′. The sleeve 110 can have a generally rectangular cross section, having a top wall 112 and bottom wall 114, and two opposed side walls 116, 118 that generally correspond to, and are aligned with, the top wall 70, bottom wall 72 and opposed side walls 74, 76 of the barrel 62 respectively. The sleeve 110 can have a sleeve cavity or channel 120 with a smaller cross sectional area than a cross sectional area of the barrel cavity 64 to thereby closely receive, and accommodate, relatively smaller clips 12′ therein.

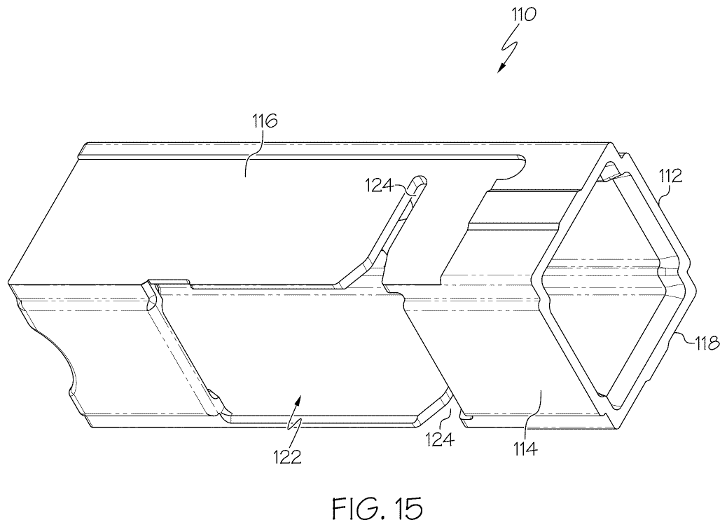

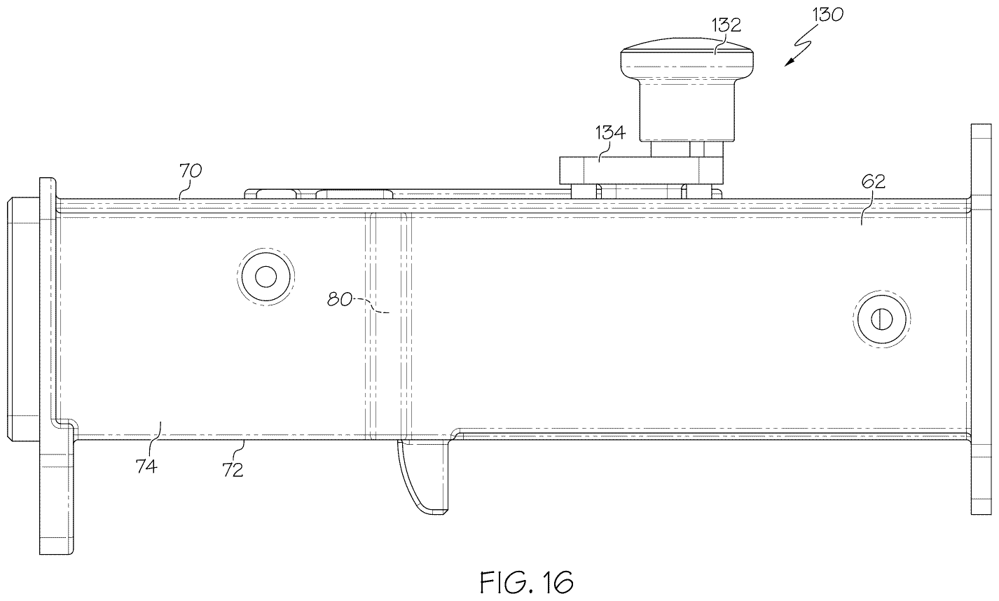

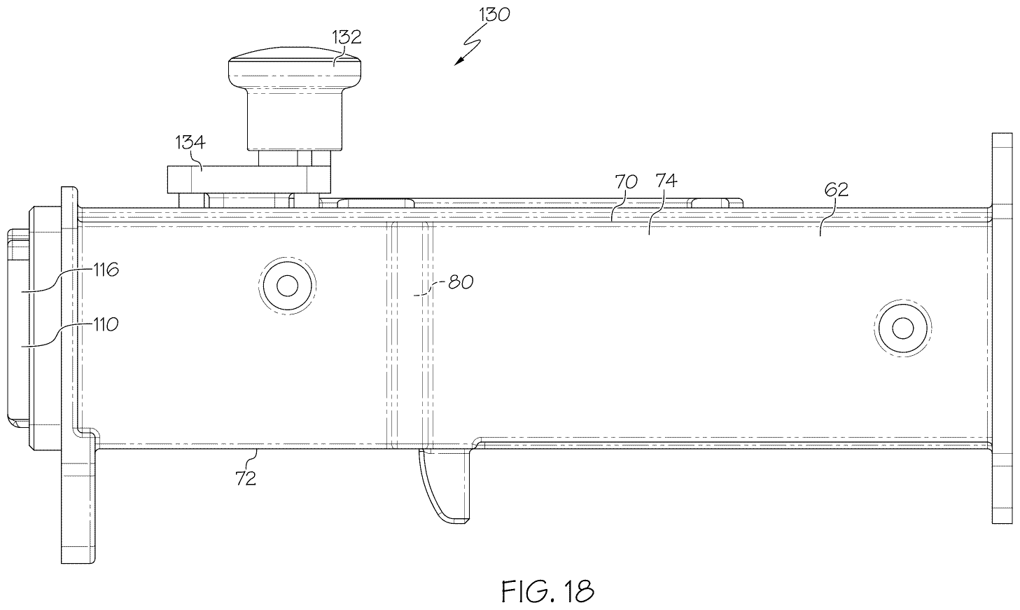

The sleeve 110 can be nestingly and slidably received in the barrel 62, and be configured for reciprocable movement in the barrel 62. In particular, the sleeve 110 can be moveable between an engaged position (FIGS. 8, 9, 10, 18 and 19) wherein the sleeve 110 is positioned relatively close to a distal end of the barrel 62, and a retracted position (FIGS. 8A, 10A, 16 and 17) wherein the sleeve 110 is positioned relatively far from the distal end of the barrel 62. The sleeve 110 can include a sleeve slot 122 (FIG. 15) formed in or defined by the bottom wall 114 of the sleeve 110 (or positioned between the side walls 116, 118). As shown in FIGS. 8, 9, 10, 19 and 20, when the sleeve 110 is in the engaged position, the sleeve slot 122 is fully or at least partially aligned with/overlapping with the barrel slot 78 so that clips 12′ can pass through the aligned slots 78, 122 and into the barrel 62, in a direction perpendicular to the length of the barrel 62. Conversely, as shown in FIGS. 8A, 10A, 16 and 17, when the sleeve 110 is in the retracted position, clips 12 can pass through the slot 78 (but not through the slot 122) and into the barrel 62.

Thus when the sleeve 110 is in the engaged position the sleeve 110 (and more particularly the sleeve slot 122) overlaps with the barrel slot 78 in the length direction, and when in the retracted position wherein the sleeve 110 (and more particularly the sleeve slot 122) does not overlap (or overlaps to a lesser degree) with the barrel slot 78 in the length direction. In addition, when the sleeve 110 is in the retracted position the sleeve 110 is positioned rearwardly/upstream of the barrel slot 78 so as to not interfere with any clips 12 from the clip string 56 entering into the barrel 62. Conversely, when the sleeve 110 is in the engaged position the sleeve 110 can extend from the barrel slot 78 to a location at or adjacent to a distal end of the barrel 62 (e.g. at or adjacent to the alignment head 66) to guide motion of a clip 12′, down the length of the barrel 62.

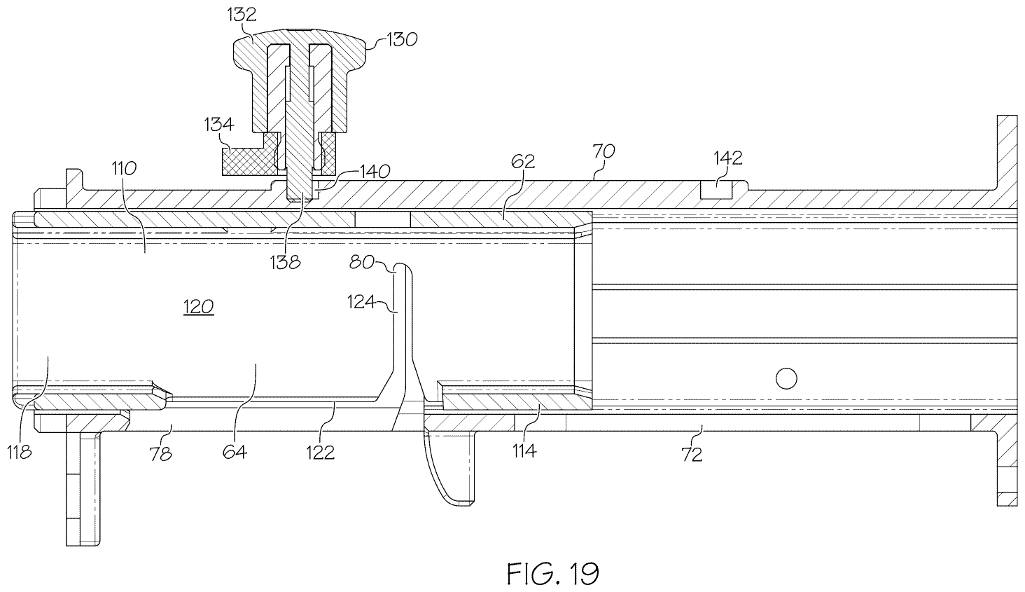

One or both side walls 116, 118 of the sleeve 110 can have a pair of sleeve channels 124 formed therein (See FIG. 15) and oriented perpendicular to a length of the sleeve 110. Each sleeve channel 124 is configured and positioned to receive clip protrusions 60, of the relatively smaller clip 12′, therein when such a clip 12′ is received in the barrel (as show in FIG. 20). The sleeve channels 124 can be configured, in one case, to be aligned and/or at least partially overlap with, with an associated barrel channel 80 when the sleeve 110 is in the engaged position, as shown in FIG. 19.

In this manner when a clip 12′ from the clip string 56′ is inserted into the barrel 62, the protrusions 60 of the clip 12′ can be received in the sleeve channels 124 to ensure the clip 12′ is properly positioned in the barrel 62. The sleeve channels 124 help to ensure the barrel-mounted clip 12′ is properly aligned, and also helps to retain the last clip 12′, of a string of clips 56′, in place in the sleeve 110 to prevent the clip 12′ from falling (vertically) out of place or exiting through the sleeve slot 172/barrel slot 78, as the protrusions 60 may be gripped by the sleeve channels 124 with a slight interference fit. In the illustrated embodiment each sleeve channel 124 is formed as a cutout extending through the associated side walls 116, 118, but could instead take the form of a recess formed in the inner surface of the associated side walls 116, 118.

When the sleeve 110 is in the retracted and/or engaged position, the piston 68 can travel down and the length of the sleeve 110 in reciprocal movement, to engage any clips 12, 12′ positioned in the sleeve 110/barrel 62, and thereby drive the clips 12, 12′ out of the sleeve 110/barrel 62 and into engagement with one or more structural members 50, 52, in the manner outlined above. In particular, when the sleeve 110 is in the retracted position, as shown in FIG. 10A, the piston 68 can first travel down all or part the length of the sleeve 110 and then travel down the remaining length of the barrel 62, engaging a relatively large clip 12 and ejecting the clip 12 out of the barrel 62. Conversely, when the sleeve 110 is in the engaged position, as shown in FIG. 8, the piston 68 can first travel down all or part the length of the sleeve 110, and the length of the barrel 62 at the same time, and the engage a relatively small clip 12′ and ejecting the clip 12′ out of the barrel 62.

The sleeve 110 can in one case be configured to be manually operated or moved between the retracted position and the engaged position. In particular, the barrel 62 can in one case include a longitudinal slot/opening 128 (in the top wall 70 in the illustrated embodiment; see FIG. 13) that extends in a direction of the desired movement of the sleeve 110 (along or parallel to a length of the barrel 62 in one case). The clip applicator 10 can include a handle 130 having a knob 132 that is coupled to a guide 134. The guide 134 has a guide protrusion 136 on an underside thereof that is slidably received in the barrel opening 128. The knob 132 has a knob protrusion 138 that is spring biased inwardly (downwardly), where the knob 132 knob protrusion 138 can be manually raised outwardly (upwardly), thereby compressing an associated spring (not shown) positioned in the knob 132. The barrel 62 has a forward protrusion recess 140 and a rearward protrusion recess 142 on an outer surface thereof, each of which is configured to removably receive the knob protrusion 138 therein. The guide 134 is configured to be coupled to the sleeve 110 by a pair of fasteners 144 that extend through the openings 146 of the sleeve 110.

The handle 130 is thus slidably received in the opening 128 of the barrel 62, and fixedly coupled to the sleeve 110. In this manner the handle 130 can be manually gripped and pushed forwardly to move the sleeve 110 forwardly from the retracted position to the engaged position. Similarly the handle 130 can be gripped and pushed rearwardly to move the sleeve 110 rearwardly from the engaged position to the retracted position. In this manner the handle 130 can be manually operated to adjust the position of the sleeve 110, in one case when no clips 12, 12′ are positioned in the barrel 62, to thereby configure the clip applicator 10 for use with relatively large 12 or relatively small 12′ clips, as desired.

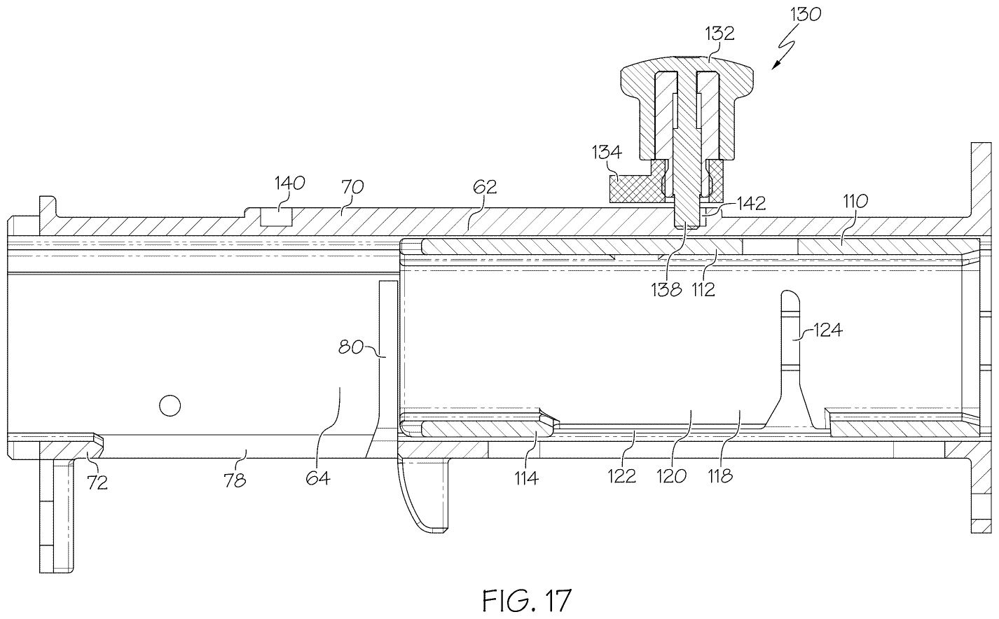

The handle 130/sleeve 110 can be configured to be retain in the retracted and/or engaged position. In particular, when the handle 130/sleeve 110 is in the retracted position, the distal end of the knob protrusion 138 can be received in the rearward protrusion recess 142, as shown in FIG. 17. The interaction between the knob protrusion 138 and the rearward protrusion recess 142 retains the handle 130/sleeve 110 in the retracted position. When it is desired to move the sleeve 110 to the engaged position, the knob 132 is manually raised, which lifts knob protrusion 138 out of the rear protrusion recess 142. The sleeve 110 is then free to slide to the engaged position, and when the sleeve 110 is in the engaged position the distal end of the knob protrusion 138 can be raised and received in the forward protrusion recess 140, as shown in FIG. 19, thereby locking the sleeve 110 in place. The clip applicator 10 can include various indicia, such as text, color, diagrams or the like to communicate to the user/operator when the sleeve 110 is in the engaged position and/or the retracted position.

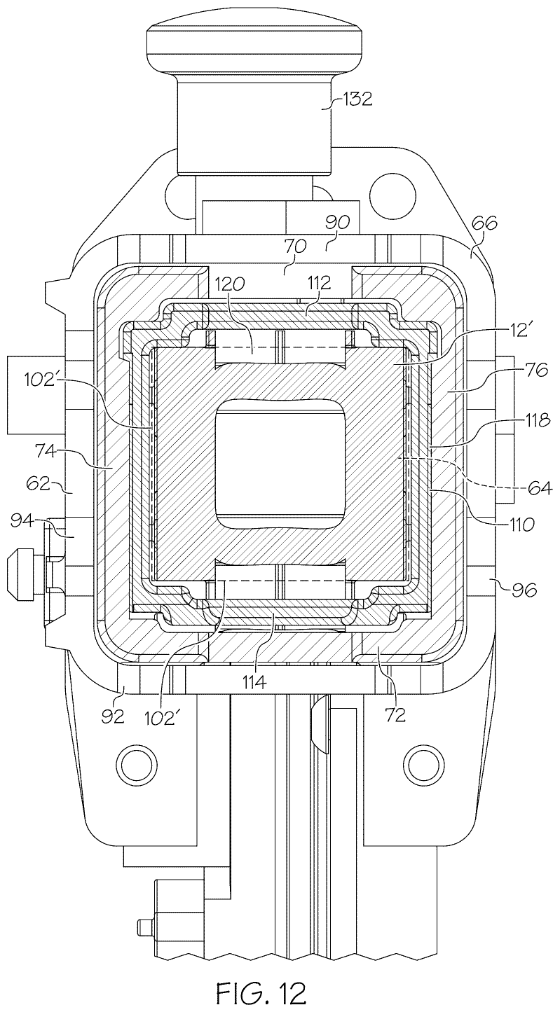

In this manner, when it is desired for the clip applicator 10 to be used with relatively smaller clips 12′, the string 56 of relatively larger clips 12 can first be removed from the barrel 62/feed mechanism 82. The sleeve 110 can be moved into its engaged position, and a string 56′ of relatively smaller clips 12′ can be positioned in the feed mechanism 82, as shown in FIG. 8A. As shown in FIG. 12, the sleeve 110 can have a smaller perimeter/cross sectional area, and be configured to closely receive the relatively smaller clip 12′ therein. In particular, in one case the sleeve 110 can have an inner hollow cross-sectional surface area (defined in one case by the outer-most portions of the sleeve channel 120) that relatively closely corresponds (within about 1% in one case, or within about 3% in another case, or within about 5% in yet another case) to a “surface area” of the relatively smaller clip 12′, wherein the surface area of the clip 12′ is defined by the smallest rectangle that can be drawn about the clip 12′ when the clip 12′ is received in the barrel 62 (as viewed looking down a length of the barrel 62, as shown by dotted line rectangle 102′ of FIG. 12, but where the sides of the rectangle 102′ are slightly spaced away from the “surface area” of the clip 12′ for ease of illustration). In one case, the cross sectional surface area of the channel 120 of the sleeve 110 is smaller than the cross sectional surface area of the cavity 64 of the barrel 62 by at least about 15% in one case, or at least about 25% in another case, or at least about 30% in yet another case, and less than about 60% in one case.

When it is desired for the clip applicator 10 to be used with relatively larger clips 12, the sleeve 110 can then be moved to its retracted position as shown in FIG. 8A. The relatively smaller clips 12′ can then be removed from the barrel 62/sleeve 110/feed mechanism 82. The clip applicator 10 is then ready to be used with relatively larger clips 12, as shown in FIG. 10A. If it is desired to use relatively smaller clips 12′, the order of operations is simply reversed. Moreover, in addition, if desired additional sleeves (not shown) can be nested inside the sleeve 110, and movable between retracted and extended positions to receive and accommodate even smaller clips as desired.

In this manner the barrel 62 is configured to closely receive relatively larger clips 12 therein when the sleeve 110 is in the retracted position, and the barrel 62 is also configured to closely receive (via the sleeve 110) relatively smaller clips 62′ therein when the sleeve 110 is in the engaged position. The sleeve 110 thus provides a mechanism that can be quickly, easily and intuitively operated to adjust the clip applicator 10 for use with differently sized clips 12, 12′. Thus use of such a sleeve 110 reduces or eliminates the need to maintain different clip applicators on a job site, which increases efficiency and reduces cost.

Having described the invention in detail and by reference to the various embodiments, it should be understood that modifications and variations thereof are possible without departing from the scope of the claims of the present application.

1. An apparatus for coupling a clip to a bar comprising:
a barrel defining a barrel cavity therein, wherein the barrel cavity is sized and positioned to receive a clip therein;
a piston configured for reciprocable movement in the barrel cavity to thereby drive a clip positioned in the cavity out of the cavity; and
a sleeve configured for reciprocable movement in the barrel cavity, wherein the sleeve has a sleeve cavity having smaller cross sectional area than a cross sectional area of the barrel cavity to thereby receive a relatively smaller clip therein.

2. The apparatus of claim 1 wherein the barrel has a barrel slot therein, wherein the barrel slot is positioned and configured to receive a clip therethrough and into the barrel in a direction perpendicular to a length of the barrel, and wherein the sleeve is moveable between an engaged position wherein the sleeve at least partially overlaps with the barrel slot in the length direction, and a retracted position wherein the sleeve does not overlap with the barrel slot in the length direction.

3. The apparatus of claim 2 wherein the apparatus is configured such that when the sleeve is in the retracted position the sleeve is positioned rearwardly of the barrel slot, and when the sleeve is in the engaged position the sleeve extends from the barrel slot to a location at or adjacent to a distal end of the barrel.

4. The apparatus of claim 2 wherein the sleeve has a sleeve slot that is at least partially aligned with the barrel slot when the sleeve is in the engaged position.

5. The apparatus of claim 2 further comprising a plurality of clips arranged in a row extending in a direction perpendicular to the length of the barrel, wherein an inner-most one of the plurality of clips is positioned in the barrel, wherein each clip has two pair of bar seats, where each seat is configured to receive part of a structural member therein, and wherein each seat is generally arcuate.

6. The apparatus of claim 1 further comprising a clip positioned in the barrel, wherein the clip has a first pair of aligned seats configured to receive a first structural member therein, a second pair of aligned seats configured to receive a second structural member therein in a position perpendicular to the first structural member, and a third pair of aligned seats configured to receive the second structural member therein in a position parallel to the first structural member.

7. The apparatus of claim 1 wherein the sleeve is reciprocal between an engaged position, where the sleeve is positioned relatively close to a distal end of the barrel, and a retracted position, where the sleeve is positioned further from the distal end of the barrel as compared to when the sleeve is in the engaged position, and wherein the piston is configured for reciprocal movement within both the piston and the sleeve.

8. The apparatus of claim 7 wherein the piston is configured for reciprocal movement within both the piston and the sleeve when the sleeve is in the engaged position, and when the sleeve is in the retracted position.

9. The apparatus of claim 1 wherein the sleeve is reciprocal between an engaged position, where the sleeve is positioned relatively close to a distal end of the barrel, and a retracted position, where the sleeve is positioned further from the distal end of the barrel as compared to when the sleeve is in the engaged position, wherein the apparatus has a feed mechanism configured to feed a clip into the barrel at a feed location, and wherein when the sleeve is in the engaged position the sleeve at least partially overlaps with the feed location along a length of the barrel and when the sleeve is in the retracted position the sleeve does not at least partially overlap with the feed location along the length of the barrel.

10. The apparatus of claim 1 wherein the sleeve is moveable between an engaged position wherein the sleeve is positioned relatively close to a distal end of the barrel and a retracted position wherein the sleeve is positioned relatively far from the distal end of the barrel, wherein the barrel has a barrel channel that is configured to receive an alignment protrusion of a clip therein, and wherein the sleeve has a sleeve channel configured to receive an alignment protrusion of a clip therein, wherein the barrel channel and the sleeve channel are both oriented perpendicular to a length of the barrel.

11. The apparatus of claim 1 wherein the sleeve is moveable between an engaged position wherein the sleeve is positioned relatively close to a distal end of the barrel and a retracted position wherein the sleeve is positioned relatively far from the distal end of the barrel, and wherein the apparatus further comprise a handle that is coupled to the sleeve to enable the sleeve to be manually moved between the engaged position and the retracted position, wherein the barrel includes an opening formed therethrough that receives part of the handle therethrough, wherein the opening at least partially extends in a direction parallel to a length of the barrel.

12. The apparatus of claim 1 wherein the sleeve is moveable between an engaged position wherein the sleeve is positioned relatively close to a distal end of the barrel and a retracted position wherein the sleeve is positioned relatively far from the distal end of the barrel, wherein the barrel is configured to closely receive a relatively larger clip therein when the sleeve is in the retracted position, and wherein the barrel is configured to closely receive a relatively smaller clip therein when the sleeve is in the engaged position.

13. The apparatus of claim 1 wherein the barrel and the sleeve each have a generally rectangular cross section, and wherein the sleeve is nestingly and slidably received in the barrel.

14. The apparatus of claim 1 sleeve cavity has a cross sectional surface area that is smaller than a cross sectional surface area of the barrel cavity by between about 15% and about 60%.

15. The apparatus of claim 1 further comprising an alignment head positioned at or adjacent to, or defining a distal end of, the barrel, wherein the alignment head has a first set of aligned, opposed notches, and a second set of aligned, opposed notched oriented generally perpendicular to the first set of notches.

16. The apparatus of claim 15 wherein the first set of notches have a deeper depth than the second set of notches.

17. The apparatus of claim 1 further comprising a manually operable actuator that is operatively coupled to the piston to actuate movement of the piston, and an electric motor that is operatively coupled to the piston.

18. An apparatus for coupling a clip to a bar comprising:
a barrel defining a barrel cavity therein, wherein the barrel cavity is sized and positioned to receive a clip therein;
a piston configured for reciprocable movement in the barrel cavity to thereby engage a clip positioned in the barrel cavity; and
a sleeve positioned in the barrel cavity and configured for movement along a length of the barrel cavity, wherein the sleeve has a sleeve cavity having smaller cross sectional area than a cross sectional area of the barrel cavity, wherein the sleeve cavity is configured to receive the piston therein to thereby engage a clip positioned in the sleeve cavity.

19. A method comprising:
accessing an apparatus including a barrel defining a barrel cavity therein, wherein the barrel cavity is sized and positioned to receive a clip therein, the apparatus including a piston configured for reciprocable movement in the barrel cavity to thereby drive a clip positioned in the cavity out of the cavity, the apparatus further including a sleeve, the sleeve having a sleeve cavity having smaller cross sectional area than a cross sectional area of the barrel cavity to thereby receive a relatively smaller clip therein; and
moving the sleeve within the barrel cavity.

20. The method of claim 19 wherein the moving step includes moving the sleeve to or from an engaged position wherein the sleeve is positioned relatively close to a distal end of the barrel, and a retracted position wherein the sleeve is positioned relatively far from the distal end of the barrel, wherein the barrel is configured to closely receive a relatively larger clip therein when the sleeve is in the retracted position, and wherein the barrel is configured to closely receive a relatively smaller clip therein when the sleeve is in the engaged position.
